(19) United States
(12) Patent Application Publication
(10) Pub. No.: US 2011/0121013 A1
(43) Pub. Date: May 26, 2011

(54) DEVICE FOR AUTOMATICALLY DISPENSING COMPONENTS

(76) Inventor: Jean Yves Delattre, Fournes en Weppes (FR)

(21) Appl. No.: 13/003,473

(22) PCT Filed: Jul. 8, 2009
(86) PCT No.: PCT/FR09/51354

§ 371 Date: Feb. 2, 2011

(30) Foreign Application Priority Data
Jul. 10, 2008 (FR) 0854701

(51) Int. Cl. B65G 59/00; B65D 83/00

(52) U.S. Cl. 221/133; 221/208; 221/223; 221/200; 221/278

(57) ABSTRACT

The invention relates to a dispenser device for dispensing components designed for enabling parts to be assembled together. The device comprises: a main storage magazine for storing the components; an extraction plate for extracting components, which plate has an inclined edge that is arranged to come to bear on the components; actuation means for actuating the plate so as to drive it in up-and-down vertical reciprocating motion, and so as to remove the components upwards; and a temporary storage system for temporarily storing the components, which system has an upstream portion arranged to come into register with the edge when the plate is in the high position, and to enable components to be transferred from the plate into said storage system, which system is provided with transfer means arranged to convey the components from the upstream portion towards a downstream portion that is designed to enable the components to be extracted in succession from the device.

The present invention relates to a device for automatically dispensing components. Such a device can be used on production or assembly lines for producing or assembling products made up of a plurality of parts that are assembled together, in particular by means of said components. The person skilled in the art concerned by the present invention is thus, more particularly, a manufacturer of automated devices for dispensing components, and more generally a manufacturer of production or assembly lines for producing or assembling products.

In addition, in order to be implemented, the described device of the invention requires said components to be specific. Each such component must necessarily be provided at least with a head and with a shank so as to form a circular shoulder, such as on a screw, or indeed so as to form a circular groove, such as on fasteners, retainers, or clips made of plastics materials and used by equipment manufacturers.

Component dispenser devices are currently known that operate by vibrating the components by means of vibratory bowl feeders. In such devices, the components are extracted and then conveyed towards one or more assembly points, which requires specific design work to be done on transferring the components, such transfer being specific to each application. Such design work usually involves high costs and long lead times for producing the assembly means. In addition, such assembly means can be complex and difficult to use.

It should also be noted that when various different components are to be assembled onto the same end product, it can be difficult to install a plurality of feeder devices on the same machine, since such vibratory feeder devices are produced specifically for each component and they are also relatively voluminous.

In addition, when feeding components that are equipped with electronic elements, such as radiofrequency identification (RFID) tags, the use of such vibratory bowl feed feeders must be avoided because they could damage such elements because of the presence of waves generated by the generator of the bowl feeder and because of the vibration emitted by such a device.

Another criterion to be taken into account is the final overall volume of the production means that should be as compact as possible and that should be suitable for complying with the ergonomics rules that are applicable when designing manufacturing means.

It should also be noted that vibratory bowl feeder devices themselves need to be fed via hoppers of the vibratory type if it is desired to reduce the frequency with which the devices are filled, since the storage capacity of vibratory bowl feeders is limited by design.

It is also known that robotic applications can be used for assembling components. However, such applications suffer from various drawbacks: their design requires a relatively long time for putting the components onto the parts to be assembled; the equipment and the peripherals are generally voluminous: and, in addition, implementing and operating them requires qualified staff. The cost of such applications is therefore high.

An object of the present invention is to mitigate the drawbacks existing on current dispenser devices. The invention makes it possible, in particular to extract components as defined above from a container in which said components are stored loose, in order to dispense them successively and individually to a localized place on a work station of the production line, it then being possible for the components to be taken hold of by an operator, by a tool, or by a manipulator arm with a view to assembling parts making up the product to be assembled.

The invention offers the advantage of significantly reducing the time required for designing the mechanisms and the controllers needed for producing the assembly line. In addition, it is suitable for being arranged locally at the work stations, while accommodating the layout of the work station, thereby avoiding the need to make major changes to the assembly line.

The dispenser device of the invention for dispensing components is, in particular, designed for enabling parts to be assembled together by means of said components. Each of the components is provided with a head and with a shank so as to form a circular shoulder or a circular groove. The dispenser device comprises at least a main magazine, an extraction plate, actuation means for actuating the plate, and a system for temporarily storing the extracted components.

The main storage magazine makes it possible for storing said components loose. Said magazine extends vertically and has at least one vertical plane. Preferably, this magazine is of square or rectangular section, defining four vertical planes on respective ones of the vertical faces of said magazine.

The extraction plate for extracting components is arranged parallel to the vertical plane; said plate has an edge at its upper end, which edge is inclined relative to the horizontal. This edge is arranged to come to bear on the shoulders or in the grooves of components situated in the magazine. In addition, its inclined position enables the component to descend, at least by gravity, in the inclination direction, towards the lower end of said edge.

The actuation means are arranged so as to drive the plate in up-and-down vertical reciprocating motion. In this way, the components having their grooves positioned bearing against the edge are removed upwards, above the components dumped loose in the magazine.

The temporary storage system for temporarily storing the components has an upstream portion arranged to come into register with a lower end of the inclined edge when the plate is in the high position, and to enable components disposed on the edge of the plate in said high position to be transferred into said storage system. In addition, the system is provided with transfer means arranged to convey the components in succession from the upstream portion towards a downstream portion that is designed to enable the components to be extracted in succession from the device, this extraction being achieved, in particular, by means of a tool, or indeed manually by an operator.

Such a temporary storage system makes it possible to compensate for fluctuations in extraction of the components by the extraction plate, thereby guaranteeing that the installation is used constantly, and avoiding problems of component procurement at the work station.

Preferably, the vertical plane is constituted by one of the vertical walls of the magazine. In addition, the plate is spaced apart from the vertical wall at a distance arranged to enable the component to be positioned so that the shoulder or the groove on or in the component is disposed facing the edge on said plate. In this way, it is guaranteed that only one position is possible for the component while it is being carried and removed upwards by the plate.

The dispenser device of the invention further comprises first pusher means for pushing the components disposed on the edge. These first pusher means are arranged so as to guarantee that the components disposed on the edge are moved towards the lower end of said edge, and then, whenever necessary, so as to guarantee that at least one component is transferred to the upstream portion of the temporary storage system before the plate moves back down into the magazine. Preferably, these first pusher means are constituted by a blower, or by a blower nozzle disposed above the plate in the high position and blowing towards the upstream portion of the temporary storage system. It is possible to provide other pusher means of the mechanical type, such as an actuator.

The transfer means of the temporary storage system are made up of at least two rails and of second pusher means for pushing the temporarily stored components.

The storage first rail is arranged to guide and to hold the components while they are being transferred from the edge of the plate. This rail is disposed in such a manner as to adjoin the lower end of the edge, when the plate is in the high position, and as to follow an inclined path corresponding substantially to the inclination of said edge. This rail constitutes the upstream portion of the temporary storage system.

The “buffer storage” second rail makes it possible for the components engaged on the first rail to accumulate.

This second rail is arranged vertically, preferably along the side edge of the vertical plane, and constitutes an extension to the first rail, while changing direction so as to extend in the height direction of the main magazine.

In addition, the second pusher means are arranged to transfer a component from the first rail to the second rail. This design makes it possible to increment successively the temporary storage of the stored components with a view to conveying them towards the downstream portion of the storage system.

Preferably, the second rail is arranged vertically upwards, and the second pusher means are constituted by a vertical pusher. The transfer means further comprise at least one non-return device making it possible to maintain the stored component in the second rail once it has been transferred from the first rail. This non-return device advantageously makes it possible to increment the components.

In addition, this vertical pusher preferably has a stroke that is sufficiently long to enable the component that is furthest downstream in the second rail to be removed to the upper end of said rail where it is held in position by means of a second non-return device that may be different from the first non-return device.

In a design embodiment, the vertical pusher is constituted by an actuator that is arranged vertically. The actuator includes a piston that has its end coming to bear against a component disposed at the end of the first rail, adjoining the second rail, so as to transfer the component to the second rail. The stroke of the piston also guarantees that the component is transferred beyond the non-return device and preferably to the upper end of the second rail when the temporary storage zone is empty. It is also possible to provide a pusher element, such as a rod, that is fitted or secured to the end of the piston, which rod comes to bear against the component.

In a variant design, the vertical pusher is constituted by a part of longitudinal shape, e.g. a rod, arranged vertically under the second rail, so as to come to bear against a component disposed at the end of the first rail and so as to transfer it to the second rail beyond the non-return device. In addition, this part is activated by the actuation means for actuating the plate. This design makes it possible to omit an additional actuator, and thus contributes to simplifying the dispenser device. In addition, in this variant, it is possible to provide a compensation spring on the part, so as to allow the extraction plate to travel over its stroke to the upper limit even when the temporary storage second rail is full of components, and thus make it possible nevertheless to transfer a component from the plate edge to the first rail, insofar as said first rail is not yet full.

The dispenser device of the invention further comprises a regulation system for regulating conveying of the components from the storage first rail to the buffer storage second rail. This regulation system is arranged to close off at least in part the passage between the storage first rail and the buffer storage second rail when components are awaiting extraction in the downstream portion of the temporary storage system. Naturally, the passage between the storage first rail and the buffer storage second rail may be closed off in full, depending on the design embodiment in question.

In a preferred design embodiment, the regulation system for regulating conveying of the components from the storage first rail to the buffer storage second rail is constituted by a non-return device. This non-return device comprises, in particular, a locking piece that is preferably pivotally mounted relative to the buffer storage second rail. In this way, when a component is passing into the buffer storage second rail for the purpose of being conveyed towards the downstream portion of the temporary storage system, said locking piece pivots from an engaged position to a disengaged position so as to allow the component to go past. In addition, the non-return device further comprises a return spring making it possible to return said locking piece to its engaged position. This locking piece comprises an upper portion, an intermediate portion, and a lower portion. The upper portion forms a non-return abutment against a component that is engaged in the second rail and that has gone past said locking piece, which locking piece is urged to return to its engaged position. The intermediate portion comprises holding means for holding a component that is inserted into the buffer storage second rail while a component is already waiting in the downstream portion of the storage system, which means that components have gone past the locking piece and are already waiting in the buffer storage second rail. The lower portion is arranged for either closing off, at least in part, or indeed in full, depending on its design, the passage between the first rail and the second rail so long as a component remains held by the intermediate portion, or, conversely opening up the passage between the storage first rail and the buffer storage second rail whenever no component is held by said intermediate portion, which means that no component is waiting in the downstream portion of the storage system and that the components can therefore go past said locking piece.

Depending on the design of the storage first rail, and on the design of the lower portion of the locking piece that makes it possible to close off either in part or in full the passage between the storage first rail and the buffer storage second rail, it is possible to make provision for the component conveyed from the extraction plate to the storage first rail, which component is then situated in the upstream portion of the temporary storage system, to remain either in the intermediate waiting position until the component disposed in the downstream portion of the temporary storage system is extracted, or to be rejected back into the main magazine.

In this way, excellent regulation is provided for the conveying of the components inside the temporary storage system. This offers the advantage of avoiding any risk of components jamming in the zone of passage between the storage first rail and the buffer storage second rail.

Preferably, the transfer means further comprise at least a third rail adjoining the upper end of the second rail. This third rail is arranged to transfer components from the inside of the magazine to the outside thereof. This third rail may, however, also be extended by a fourth rail arranged vertically downwards outside the wall of the main magazine, the lower end of which fourth rail then constitutes the downstream portion of the temporary storage system.

The dispenser device further comprises mixer means for mixing the components dumped in the main magazine. These mixer means are arranged to stir the components and to change their positions in the magazine. These mixer means are, for example, constituted by a support element. This support element is disposed at the bottom of the magazine and is secured to the plate; it may be flexible or made up of a plurality of plates that are hinged together and to the vertical plate. While the plate is moving vertically, the support element is then entrained by said plate, thereby making it possible to incline it or to raise it at least in part relative to the bottom of the magazine, thereby guaranteeing that the components dumped in said magazine are mixed. It is thus possible to prevent the components as dumped loose from stagnating in the magazine, thereby increasing the possibility of removing at least one component that is positioned on the edge of the vertical plate, which plate moves in up-and-down reciprocating motion.

Other mixer means may be considered, such as, for example, a blower system disposed at the bottom of the magazine, vertical rods passing through the bottom of the magazine, and being actuated vertically and simultaneously with the vertical plate, or indeed merely an additional plate of thickness greater than the thickness of the main plate to which it is fitted.

Preferably, the actuation means for actuating the plate are constituted by a pneumatic actuator. The use of pneumatic drive offers the advantage of overcoming any problems of the actuator jamming due to components jamming in the main magazine. Thus, in the event of a jam, the actuator stops its stroke until the next cycle, whereupon it moves back down again, thereby enabling the components to move inside the magazine, and thus enabling the jam to be cleared.

The dispenser device further comprises a secondary magazine coupled at an opening preferably provided in the upper portion, in one of the vertical walls of the main magazine, other than the wall constituting the vertical plane. In addition, the device further comprises a gate for closing the opening and control means for controlling the gate so as to fill the main magazine by it being fed from the secondary magazine once the main magazine has reached a minimum level.

It is also possible to provide a plurality of secondary magazines disposed in cascade, with, for example a vertical arrangement, the cascade making it possible to reduce the volume and above all the height of the main magazine with a view to reducing the stroke of the extraction plate for extracting the components and thus to reducing the stroke of the actuator.

Preferably, the gate is mounted to slide vertically relative to the vertical wall of the magazine, so as to enable it to be moved vertically relative to the opening. However, it is possible to provide a gate that is mounted to pivot relative to the opening, in the same plane as the vertical wall of the main magazine that is provided with the opening.

In a preferred embodiment, the control means for controlling the gate comprise a horizontal ledge secured to or integral with the inside face of the slidably mounted gate, and extending above the components dumped in the main magazine.

Similarly, in this preferred embodiment, said control means further comprise a vertical actuation system, constituted by a finger disposed on the extraction plate and coming to bear either against the horizontal ledge, or against another ledge constituting an abutment and disposed on the gate below the magazine. This system is arranged to move the gate, in such a manner as to maintain the ledge in abutment on the tops of the components, thereby making it possible to close off the opening so long as the main magazine contains such components, while the gate goes below the opening naturally once the magazine reaches a minimum component-content threshold, thereby making it possible to transfer components from the secondary magazine to the main magazine. In addition, these control means further comprise a position sensor that detects that the magazine has reached a limit threshold at which the sensor, in this preferred embodiment, activates an alarm signal for indicating that the secondary magazine is also empty.

In a variant design, the vertical actuation system is constituted by a vertical actuator. In this variant design, the actuator makes it possible, conversely, to maintain the gate in front of the opening and then to force the gate to open the opening by moving below it, or indeed above it, when the minimum threshold is reached. In this variant design, the presence of a sensor activates the actuator for actuating the gate and for enabling the secondary magazine to release the components so that they then fill the main magazine.

Other characteristics and advantages of the present invention can appear on reading the following description of a preferred design embodiment of the dispenser device, in particular designed for fasteners made of plastics materials, and shown in the figures, in which:

FIG. 1 is a diagrammatic view of an example of a component of the fastener type dispensed by means of the device of the invention;

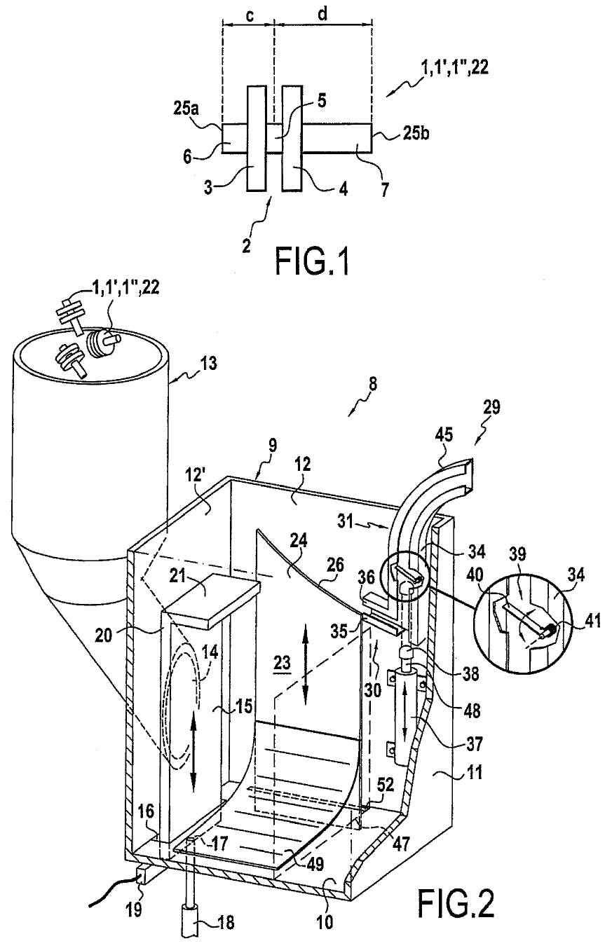

FIG. 2 is a fragmentary diagrammatic view of the dispenser device, showing the layout of the component elements of said device;

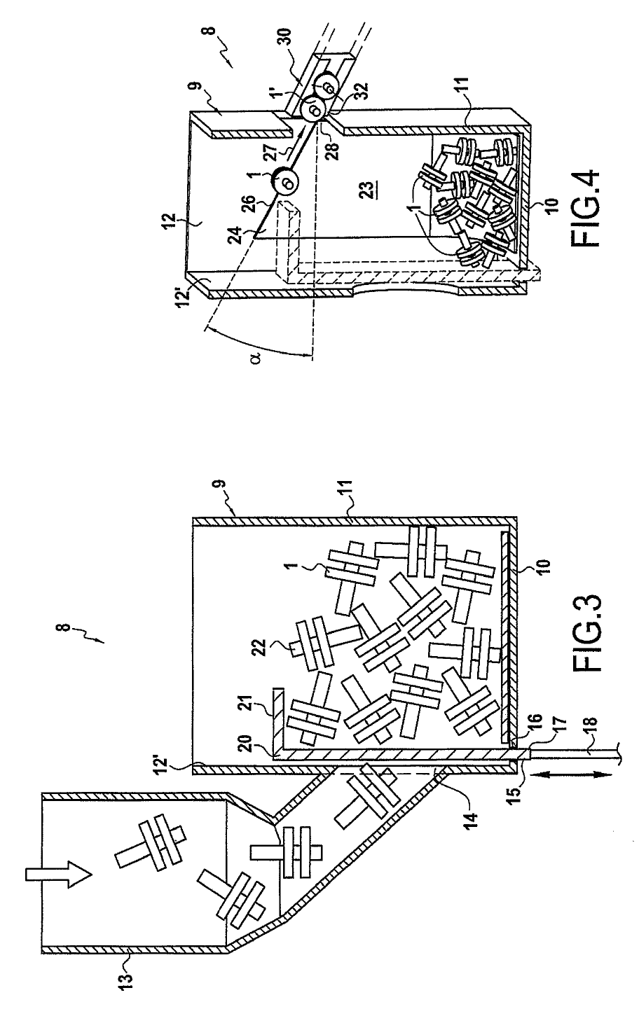

FIG. 3 is a diagrammatic view of a secondary magazine, adjoining the main magazine and coupled thereto at an opening, and of a gate for closing said opening;

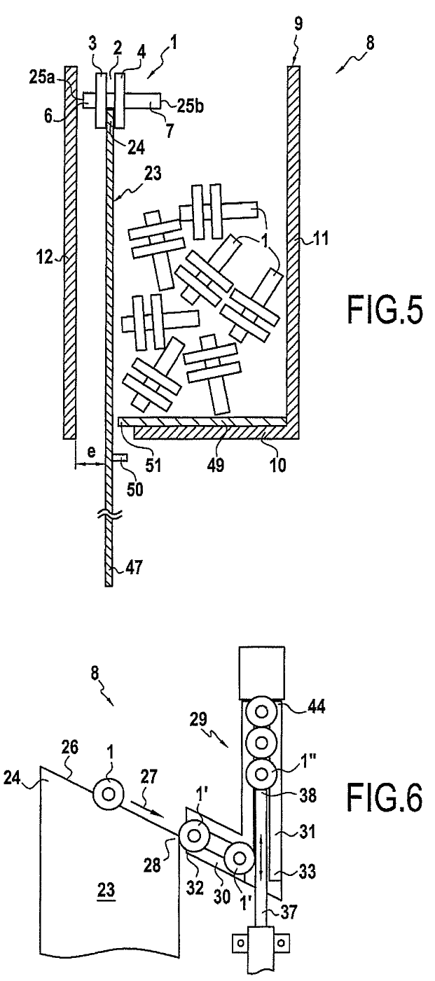

FIGS. 4 and 5 are diagrammatic views of the extraction plate during a stage for removing a component from among the other components stored loose in the main magazine;

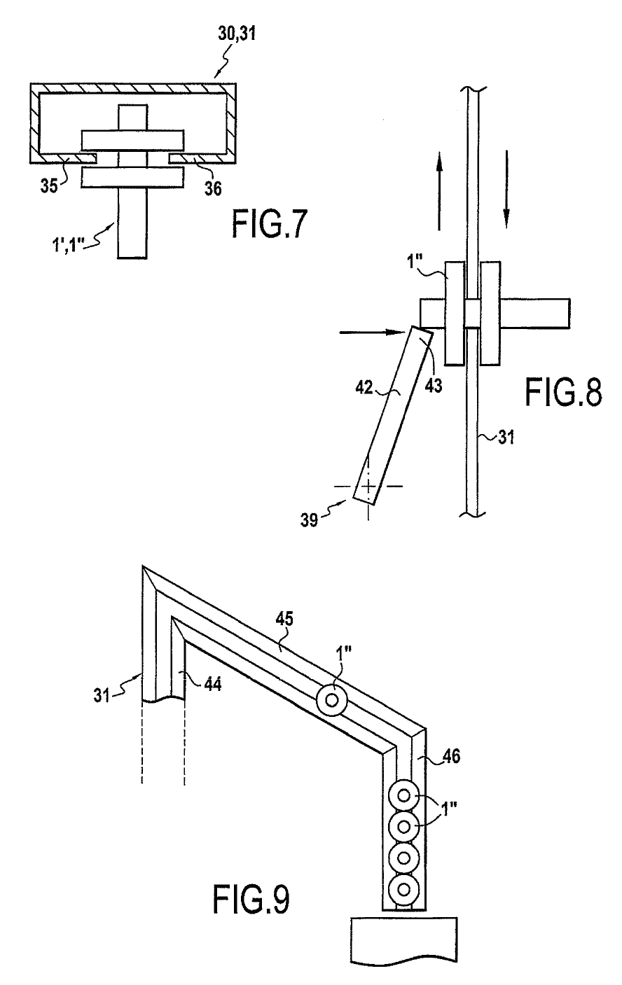

FIGS. 6 and 7 are diagrammatic views showing the transfer means for transferring the components to a temporary storage system;

FIG. 8 is a diagrammatic view of a non-return device;

FIG. 9 is a diagrammatic view of third and fourth rails making up a portion of the transfer means for transfer to the temporary storage system, in a variant;

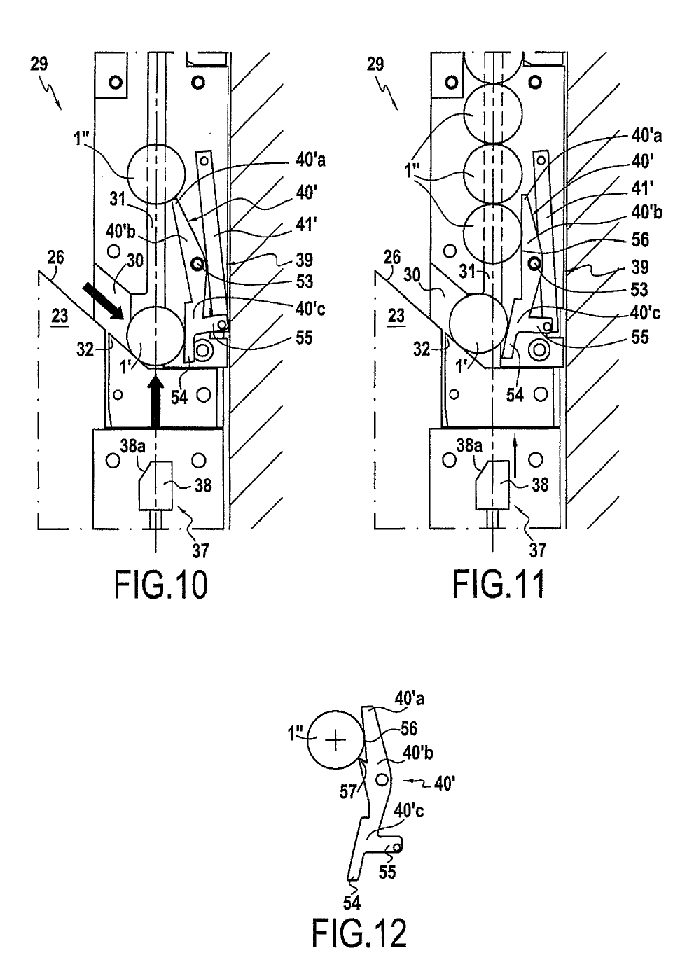

FIGS. 10 and 11 are views of a regulation system for regulating conveying of the components inside the temporary storage system, showing the locking piece respectively in the engaged position and in the disengaged position; and

FIG. 12 shows a variant design of the locking piece of the regulation system.

The following description is given by taking as an example components 1 of the fastener, retainer or clip type, as shown in FIG. 1. Such a fastener or retainer 1 has, in particular, a circular groove 2 made up of two cheeks 3, 4 held apart by an axial portion 5, which cheeks may be of different shapes and of different sizes, depending on the parts to be assembled together. Additional technical elements 6, 7, in the form of axial extensions, relating to the function to be performed by the components, may be disposed on either side of the cheeks 3, 4. The space occupied by the technical elements 6, 7 is characterized by the dimensions c and d in FIG. 1. These components may also be constituted by screws.

In which case, the technical element 6 is omitted, with the dimension c being reduced to its minimum, i.e. to the thickness of the cheek 3 constituted by the screw head; while the cheek 4 is reduced to its minimum in such a manner as to coincide with the axial portion 5 and with the technical element 7, which also coincides with said axial portion 5, these elements being constituted by the threaded axial portion of the screw, the length of which portion defines the dimension d, the screw head and the threaded portion forming a circular shoulder. Other components may be considered, such as nails or studs.

Said groove 2, or indeed said shoulder, enables the component 1 to be taken hold of during extraction and transfer stages, as described in more detail below.

In accordance with the invention, the dispenser device 8, shown in FIG. 2, has a main magazine 9, in which the components 1 are disposed loose, as shown in FIGS. 3 to 5. The magazine 9 has a bottom 10 and a wall 11 that extends vertically. The wall 11 is preferably of rectangular or square section, in a manner such that one of its side faces constitutes a vertical plane 12. Such a vertical arrangement of the magazine 9 makes it possible to limit its footprint and to be fitted easily and directly to the work station. In addition, such a rectangular or square section makes it easy to modify the arrangement of the elements of the device so as to adapt installation of it on the work station as well as possible.

Preferably, the dispenser device has a secondary magazine 13, shown in FIGS. 2 and 3, in which magazine the components 1 are stored temporarily; this design offers the advantage of having greater flexibility for refilling the main magazine 9 with components, at the work station.

In this design, an opening 14 is provided in a second vertical wall 12′ constituted by one of the faces other than the face constituting the vertical plane 12. In addition, the secondary magazine 13 is coupled to said opening 14.

A closure gate 15 is arranged on the inside of the wall 11, at the opening 14, so as to separate the main magazine 9 physically from the secondary magazine 13. Preferably, said gate 15 is mounted to slide vertically relative to the wall, the bottom 10 of the magazine being provided with an orifice 16 through which the lower end 17 of the gate 15 can pass.

In a design embodiment, said end 17 is connected to control means that make it possible to actuate the gate vertically so as to open up the opening 14 and so as to fill the main magazine 9 with components that are previously contained in the secondary magazine 13, and so as to close off the opening 14 once the main magazine 9 has been filled. For example, said control means for controlling the gate 15, shown in FIGS. 2 and 3, are constituted by an actuator 18 secured to the gate 15 at the lower end 17 thereof, which actuator 18 causes said gate 15 to move vertically upwards so as to raise it and so as to move it out of the way of the opening 14.

Similarly, said control means include a sensor 19 that, for example, monitors the position of the lower end 17 of the gate 15, or indeed the position of its upper end 20. The control means also include a ledge 21 extending horizontally or at a slight inclination at said upper end 20, on the inside face of the gate 15, said ledge 21 coming to bear against the components 22 disposed in the upper portion of the main magazine 9. The ledge 21 bears continuously against the components 22, thereby enabling the gate 15 to move downwards as the main magazine 9 is being emptied of components. Once the level has decreased sufficiently, the sensor 19 detects the position of the gate 15, the actuator 18 then raising said gate so as to open up the opening 14 and so as to insert other components that were stored in the secondary magazine 13. When the actuator 18 is deactivated, the ledge 21 then resumes bearing against the components 22.

Other types of actuator may be used rather than the actuator 18, such as, for example a rack device. Similarly, other positions may be considered for the sensor 19.

In a variant design, an abutment element is secured to or integral with an extraction plate 23 driven in up-and-down reciprocating motion; this extraction plate 23 is described in more detail below. Said abutment element preferably comes to bear against the horizontal ledge 21 of the gate 15, which gate closes off the opening 14 between the main magazine 9 and the secondary magazine 13. The movements of the extraction plate 23 thus make it possible to actuate the gate 14 vertically, said gate 15, on descending, being held in the position in which it closes off the opening 14 by the fact that the horizontal ledge 21 remains bearing against the components 22. When the main magazine 9 has reached a limit threshold and when the extraction plate 23 descends into the low position, the gate then goes below the opening 14, thereby making it possible for said main magazine 9 to be filled. Then, on rising again, the extraction plate 23 entrains the gate 15 and the horizontal ledge 21 then goes above the components 1 again so as then to resume bearing against the components 22, on the top of the stack. In this design, provision is preferably made for the ledge 21 to be inclined downwards into order to make it easier for the components 1 to slide on said ledge 21 during filling of the main magazine 9 and then while the gate 15 is rising again.

The secondary magazine 13 is fed via its top, either directly via a top opening, or via any other means such as a chute or an additional feed magazine.

This feed device guarantees a stable level for the components 1 in the magazine 9, thereby also guaranteeing a uniform extraction rate.

The dispenser device 8 also has an extraction plate 23, shown in FIGS. 2, 4, 5, and 6. This extraction plate is driven in up-and-down reciprocating motion. This plate 23 is of thickness smaller than the width of the groove 2 in such a manner as to enable it to be inserted between the two cheeks 3, 4 on each of the components, as shown in FIG. 5. The up-and-down linear reciprocating motion of the plate 23 enables its upper end 24 to take a random number of components 1, said upper end 24 of the plate coming to be received in the groove 2.

The plate 23 is spaced apart at a predetermined distance e from the wall 12 of the main magazine 9, as shown in FIG. 5. This distance e corresponds substantially to the distance c between the end 25a of the first technical element 6 and the groove 2. In addition, this distance e is less than the distance d between the end 25b of the second technical element 7 and said groove 2. In this way, the positioning of the groove 2 relative to the plate 23 is guaranteed, as is the orientation of the component 1 raised by the plate 23. When the component is a screw, this distance e is defined by the thickness of the screw head itself.

Over its upper portion 24, the plate 23 has an edge 26 that is inclined at an angle α relative to the horizontal, and that is shown in FIG. 4, so that the components engaged over the edge 26 are caused to move in the same direction as the inclination. It is also possible to make provision for the edge 26 to have a curved shape, as shown in FIG. 2. The inclination of the edge makes it possible for the components to move by gravity. However, in view of the small weight of components of the plastics-material fastener type, the device 8 has first pusher means for pushing the components 1 in the direction indicated by the arrow 27 shown in FIG. 4. These first pusher means are preferably constituted by a blower disposed in the vicinity of the lower end 28 of the edge 26. In addition, said pusher means remove the component 1 disposed at the lower end 28 of the edge 26 towards a temporary storage system 29 for temporarily storing the removed components 1′, as shown in FIG. 6.

To this end, the temporary storage system 29, shown in FIGS. 2, 4, and 6, has transfer means arranged to convey the components in succession from the upstream portion of the storage system towards the downstream portion thereof, where the component can be taken hold of by a tool on the work station. For this purpose, the temporary storage system 29 is made up of two rails 30, 31 and of second pusher means, said pusher means being arranged so as to transfer a component 1′ from the first rail 30 to the second rail 31.

The “storage” first rail 30 has its upstream end 32 adjoining the lower end 28 of the edge 26 of the plate, when said plate is in the high position. In addition, the rail 30 has an inclination that is preferably slightly less than the inclination of the edge 26. This makes it possible to guarantee continuity between the edge 26 of the plate 23 and the storage rail 30 while the component 1, 1′ is being transferred, while also facilitating removal of the component while it is being transferred from the first rail 30 to the second rail 31. In addition, this makes it possible to guide and to hold the component while it is being transferred, the cheeks 3, 4 remaining appropriately in position and passing in continuous manner from the plate 23 to the first rail 30.

The “buffer storage” second rail 31 has its upstream end 33 adjoining the first rail 30, as shown in FIG. 6, thereby making it possible for the component to come into abutment against said upstream end 33. In addition, said second rail 31 extends vertically upwards inside the main magazine 9, preferably along its side edge 34, shown in FIG. 2, and it makes it possible to accumulate the components 1″ temporarily, as shown in FIG. 6.

The rails 30, 31 may be of channel-section as shown in FIG. 7, provided with two ends 35, 36 spaced apart by a slot of width corresponding to the diameter of the axial portion 5, and of thickness making it possible to insert the groove 2 of the component 1, 1″ between said ends 35, 36. However, it is possible to consider having merely a plate provided with a slot, in a manner similar to the slot between the two ends 35, 36.

The second pusher means of the temporary storage system 29 are constituted by a vertical pusher 37, shown in FIG. 6. Actuation of the vertical pusher 37 enables its end 38 to be driven upwards, thereby enabling the component 1′ disposed in the first rail 30 to be pushed into abutment against the upstream end 33 of the second rail 31, inside said second rail 31. However, it is possible to provide a vertical rod fitted to the end 38, which rod comes into abutment against the component when the vertical pusher 37 is actuated.

In addition, a non-return device 39 makes it possible to maintain the component 1″ stored in the second rail 31, once said component is engaged by the vertical pusher 37. This non-return device 39, shown in FIG. 2, is, for example, constituted by a locking piece 40 that is pivotally mounted and that is loaded by a return spring 41. However it is possible to provide a non-return device 39 of the flexible blade type 42 having its end 43 coming to bear against the component 1″, as shown in FIG. 8.

In addition, the components 1″ are locked in the second rail 31 by the non-return device 39 against which said components 1″ come to bear, which components rest on said non-return device by means of gravity and of the vertical arrangement of said second rail 31. As a result, inserting another component 1″ makes it possible to cause said components 1″ as accumulated in the second rail 31 to advance until they reach the upper end 44 of said second rail 31 that optionally constitutes the downstream portion of the storage system 29, where the component that is furthest downstream can be removed.

In a variant design shown in FIGS. 10 to 12, said non-return device 39 constitutes a system for regulating conveying of the components as they pass from the storage first rail 30 to the buffer storage second rail 31. The non-return device 39 is arranged to close off at least in part the passage between the first rail 30 and the second rail 31 when a component 1″ is awaiting extraction in the downstream portion of the storage system 29, it being possible for said downstream portion to consist in the upper end 44 of said second rail 31 as shown in FIG. 11.

For this purpose, the non-return device 39 has a locking piece 40′ that is mounted to pivot relative to the second rail 31 by means of a pivot link 53. Thus, the locking piece 40′ can pivot from an engaged position shown in FIG. 10 and in which a component 1″ is stored on the second rail and is conveyed by means of the vertical pusher 37 towards the downstream portion of the temporary storage system 29, said component 1″ causing the locking piece 40′ to pivot into a disengaged position making it possible for said component to go past. Once the component 1″ has gone past said locking piece, said locking piece can then return to its engaged position shown in FIG. 10. For this purpose, the non-return device 39 also has a return spring 41′ that brings the locking piece 40′ back into its engaged position, in which the upper portion 40′a of said locking piece 40′ forms a non-return abutment against the component 1″ that tends to descend by gravity because of the vertical position of the second rail 31.

The locking piece 40′ also has an intermediate portion 40′b that is provided with holding means for holding a component 1″ inserted in the second rail while a component is already waiting in the downstream portion of the storage system, meaning that components 1″ that have already gone past the locking piece 40′ are stored temporarily in the second rail 31, as shown in FIG. 11. The vertical pusher 37 urges the component 1″ towards the downstream portion of the second rail 31, thereby making it possible to pivot the locking piece 40′ towards its disengaged position as shown in FIG. 11. However, said component 1″ remains blocked because of the presence of other components 1″ waiting in the downstream portion of the second rail 31, it not then being possible for said component 1″ to go past the locking piece 40′. The holding means of the intermediate portion 40′b then make it possible to hold said component 1″ that tends to move back down by gravity, thereby firstly holding said component in position and secondly holding the locking piece in the disengaged position as shown in FIG. 11, while the vertical pusher 37 is going back down again for taking the next component.

In order to prevent the vertical pusher 37 from taking an additional component when the buffer storage zone in the downstream portion of the second rail 31 is already full, the locking piece 40′ has a lower portion 40′c that is arranged to close off at least in part the passage from the first rail 30 to the second rail 31. For this purpose, the lower portion 40′c of the locking piece 40′ has the shape of a rear heelpiece 54 that, when said locking piece is in the disengaged position, makes it possible to close off said passage. In FIG. 11, it can be observed that the rear heelpiece on the lower portion 40′c closes off the passage between the first rail 30 and the second rail 31 in part. However, provision may be made for it to close off said passage in full, depending on the shape of the heelpiece that, conversely, when the locking piece is in the engaged position, shown in FIG. 10, enables the component 1′ to be positioned appropriately so that it can be conveyed along the second rail 31 under the action of the vertical pusher 37.

In its lower portion 40c′, the locking piece 40′ has a tab 55 extending forwards and to which the end of the return spring 41′ is fastened, which tab 55 makes it possible to constitute a lever arm for pivoting the locking piece 40′ into its engaged return position.

In an embodiment, and in particular when the components are made of a plastics material, i.e. are light in weight, the holding means on the intermediate portion 40′b of the locking piece 40′ are constituted merely by the return force of the spring 41′ that makes it possible for the bearing face 56 of the intermediate portion 40′b to exert clamping on the component 1″, as shown in FIG. 11. In a variant shown in FIG. 12, an additional barb 57 may be provided that holds the component 1″ by forming an abutment thereagainst.

In the embodiment shown in FIGS. 10 to 12, and in which the rear heelpiece 54 on the lower portion 40′c of the locking piece 40′ performs closing off in part between the first rail 30 and the second rail 31, a beveled portion 38a is provided at the end 38 of the vertical pusher 37, which beveled portion makes it possible to push back the component 1′ held blocked by the rear heelpiece 54 at the passage between the first rail 30 and the second rail 31, thereby, as a function of the length of the storage first rail 31, making it possible either to push the component 1′ back into a waiting position until space becomes available in the downstream portion of the second rail 31, which makes it possible for the vertical pusher 37 to push the component 1″ held by the intermediate portion 40′b, which component then goes past the locking piece 40′, thereby allowing the locking piece to return to its engaged position, or to push the component 1′ back into the main magazine 9 where it is possibly taken again by the extraction plate 23. This avoids the risks of components becoming jammed in the zone of passage between the first rail 30 and the second rail 31.

Naturally, it is possible to provide a regulation system for regulating conveying of the components from the storage first rail 30 to the buffer storage second rail 31, independently of the non-return device 39, without going beyond the ambit of the invention.

Preferably, the stroke of the end 38 of the vertical pusher 37 or the stroke of the vertical rod fitted thereto, makes it possible to reach the upper end 44 of the second rail 31 in such a manner as to guarantee transfer of a component to the downstream limit of said second rail 31, said component 1″ being, in particular, the component that is furthest downstream when components 1″ are already temporarily stored in said second rail 31, or indeed the component that is being transferred when said second rail is empty. It is also possible to provide means for holding the component brought to the downstream end of the second rail, such as a non-return device that is optionally similar to the non-return device 39.

Preferably, the transfer means include a third rail 45, or indeed a fourth rail 46, which rails are shown in FIG. 9. The third rail 45 adjoins the upper end 44 of the second rail 31 in order to extend it continuously while changing the path of conveying of the components, and it extends at a slight downward inclination relative to the horizontal, in order to facilitate descent by gravity from the inside towards to the outside of the main magazine 9. This rail thus makes it possible to remove the components from the magazine 9 so that they are taken hold of by an operator, by a fitting tool, or by a manipulator arm on the work station. In addition, it also constitutes an additional buffer storage zone. Furthermore, adding a fourth rail 46, arranged vertically downwards, makes it possible to convey said components so that they can be extracted at a lower level, depending on the layout of the work station.

Preferably, as shown in FIG. 2, a radius of curvature is provided between the upper end 44 of the second rail and the third rail 45. The same apples between the third rail 45 and the fourth rail 46. This radius of curvature makes it possible to transfer the component directly from the second rail 31 to the third rail 45 merely by pushing the component by means of the vertical pusher 37. The same applies from the third rail 45 to the fourth rail when said third rail 45 is full. However, it is possible to provide a radius of curvature that is different between the second rail 31 and the third rail 45 in order to change the orientation of the components at the outlet.

Actuation means for actuating the plate 23 make it possible to drive it in up-and-down reciprocating motion. Said actuation means are constituted by an actuator secured to the plate 23, in particular at its lower end 47. The design of said actuator is arranged to stop the stroke of the plate 23 anywhere, depending on any jamming of said plate by components 1 contained in the main magazine 9.

Preferably, said actuator is constituted by at least one pneumatic actuator, particularly suitable for this application. These actuators are controlled by a control function that may be constituted, in simple manner, by a time base that does not need any end-of-stroke sensors to be implemented. The use of pneumatic actuators offers the advantage of allowing any jamming of the movements of the plate 23, without damaging the components 1 during said jamming. The time base reverses the movement after a few seconds, the movement of the components 1 inside the magazine enabling the system to resume normal operation during the next cycle. Thus, the mechanisms can be stopped at any time and such stopping does not require any automatic control. Re-starting can also take place in any position.

The plate 23, designed to extract the components, is driven in linear reciprocating motion in a plane parallel to the vertical plane 12. This reciprocating movement is guaranteed by linear guiding. For this purpose, an orifice 52 is provided in the bottom 10 of the main magazine 9, which orifice makes it possible for the plate 23 to pass through. In addition, the plate 23 is, for example, slidably guided over its vertical path between two end positions, namely a low end position and a high end position. While the plate 23 is moving from the low position to the high position, the edge 26 is suitable for being received in the circular groove(s) 2 in one or more components 1′ contained in the magazine 9, thereby making it possible to extract said component(s). When the plate 23 is in the high position, a sufficient stop time enables the component 1 to roll along the edge 26 and to reach the lower end 28.

In reciprocating manner, the plate 23 is either in its high position, in contact with the components 1, or in its low position, which low position makes it possible for the components 1 to fill the space between the vertical plane 12 and the plate 23, above the edge 26. A component 1 is not always caught on the upper portion 24 of the plate 23 while said plate is rising. The frequency with which the components are caught depends in particular on the level of the components 1, 22 contained in the magazine 9 and on the orientations of said components. Thus, components 1 are extracted and placed in the storage first rail 30 erratically, which rail can preferably contain a plurality of components 1′. The temporary storage system 29 makes it possible to compensate for the effect of the components 1 being extracted erratically. For this purpose, the dispenser 8 is dimensioned in a manner such that the mean rate of extraction of the components 1 is greater than the rate required by the application on the work station.

It should also be noted that when the first rail 30 is full, any component 1 extracted by the plate 23 falls back into the magazine 9, and this continues until space becomes available in said storage rail 30.

In an embodiment, the vertical pusher 37 is constituted by a pneumatic actuator that is arranged vertically, as shown in FIG. 2. The end of the piston 48 thus constitutes the end 38 of said actuator, which end comes to bear against a component 1′ disposed at the end of the first rail 30. The stroke of the piston 48 is dimensioned in such a manner as to guarantee transfer of the component 1′ to beyond the non-return device 39 and preferably to the upper end 44 of the second rail 31, which end can be provided with a second non-return device of design similar to or different from the design of the non-return device 39.

In a variant embodiment, the vertical pusher 37 is constituted by a part of longitudinal shape, of the rod type, as shown in FIG. 6, which part is arranged vertically under the second rail so as to come to bear against the component 1′ disposed at the end of the first rail, and so as to transfer it into the second rail, beyond the non-return device 39. This part is actuated by the actuation means for actuating the plate 23, namely the pneumatic actuator. This design offers the advantage of using a single actuator for controlling both the plate 23 and also the vertical pusher 37, but it does, however, require the length of the rod to be dimensioned appropriately as a function of the stroke of the plate 23 actuated by said pneumatic actuator.

In addition, in this variant, it is possible to provide a part or rod made up of two elements between which a compensation spring is arranged, which spring is compressed when the secondary rail 31 is already full, thereby making it possible, nevertheless, for the extraction plate 23 to finish its stroke for the purpose of possibly placing a component 1 in the first rail 30.

Whereas, in the first solution, the use of an independent pneumatic actuator for the vertical pusher 37 makes it possible to limit the stroke thereof as a function of the number of components contained in the buffer zone constituted by the second rail 31. In addition, the pneumatic actuator constituting the vertical pusher 37 and the pneumatic actuator of the actuation means for actuating the plate 23 operate in opposition and are controlled by the same dispenser, thereby firstly limiting the manufacturing cost of the installation and secondly making it possible to vacate space in the first rail 30 so as to place a component therein the next time the plate 23 rises.

The dispenser device is provided with mixer means for mixing the components placed in the main magazine 9, as shown in FIGS. 2 and 5. These mixer means are arranged to stir the components 1 and to modify their positions in the magazine 9. Said mixer means are constituted by a support element 49 disposed at the bottom 10 of the magazine 9. By way of example, the support element 49 is secured to the plate 23 by adhesive bonding, as shown in FIG. 2. In a variant shown in FIG. 5, an abutment 50 is secured to or integral with the inside face of the plate 23, the vertical movements of the plate 23 making it possible to move said abutment 50 upwards, which abutment bears against the end 51 of the support element 49 for the purpose of raising it and of inclining it at least in part at the bottom of the magazine 9, thereby making it possible to stir the components 1. It is also possible to provide an element such as a secondary plate of larger thickness that is fitted to the inside face of the extraction plate 23, which element comes into contact with the component while the extraction plate 23 is moving back and forth.

It is, however, possible to provide other mixer means, such as a blower arranged within the magazine 9, this being possible when the components 1 are fasteners that are made of plastics materials and that are lightweight enough for such mixing to be performed by blowing.

All of the dimensional characteristics and the frequencies of the movements of the various mechanisms are determined as a function of the desired cycle time, i.e. of the time between occasions on which components are taken by an operator, by a tool, or by a manipulator arm, for example.

The present invention makes it possible to constitute an independent dispenser 8 for extracting and transferring components, implemented directly on each work station. In addition, its design makes it highly modular, enabling it to be adapted as a function of the configuration of the work station on which it is to be arranged. In addition, their compactness makes it possible for them to be placed in the vicinities of the parts to be assembled by means of said components 1.

1. A dispenser device for dispensing components, in particular components designed for enabling parts to be assembled together by said components, each of which components is provided with a head and with a shank so as to form a circular shoulder or a circular groove, said dispenser device comprising at least:
a main storage magazine that stores said components loose, which magazine extends vertically and has at least one vertical plane;
an extraction plate that extracts components, which plate is arranged parallel to the vertical plane, said plate having an edge at its upper end, which edge is inclined relative to the horizontal and is arranged to come to bear on the shoulders or in the grooves of components;
an actuation mechanism that actuates the plate so as to drive it in up-and-down vertical reciprocating motion, and so as to remove the components upwards while their grooves are bearing against the edge; and
a temporary storage system that temporarily stores the components, which system has an upstream portion arranged to come into register with a lower end of the inclined edge when the plate is in the high position, and to enable components to be transferred from the plate into said storage system, said system being provided with a transfer mechanism arranged to convey the components in succession from the upstream portion towards a downstream portion that is designed to enable the components to be extracted in succession from the dispenser device.

2. The dispenser device according to claim 1, wherein the vertical plane is constituted by comprises one of the walls of the magazine, the plate being spaced apart from the wall at a distance e arranged to enable the component to be positioned so that the shoulder or the groove on or in the component is disposed facing the edge on said plate.

3. The dispenser device according to claim 1, which device further comprises a first pusher for pushing the components disposed on the edge so as to guarantee that said components are moved towards the lower end of said edge, and so as to guarantee that said components are transferred to the upstream portion of the temporary storage system.

4. The dispenser device according to claim 3, wherein the first pusher comprises a blower.

5. The dispenser device according to claim 1, wherein the transfer mechanism of the temporary storage system comprises at least:
a storage first rail arranged to guide and to hold the components while they are being transferred from the edge of the plate, which rail is disposed in such a manner as to adjoin the lower end of the edge in the high position and as to extend the inclined path of said edge, the end of said rail constituting the upstream portion;
a buffer storage second rail making it possible for the components to be stored temporarily, which second rail is arranged vertically along the side edge of the vertical plane, said rail constituting an extension to the first rail; and
a second pusher arranged to transfer a component from the first rail to the second rail.

6. The dispenser device according to claim 5, wherein the second rail is arranged vertically upwards, the second pusher means comprising a vertical pusher, the transfer mechanism further comprising at least one non-return device making it possible to maintain the component in the second rail once it has been transferred from the first rail.

7. The dispenser device according to claim 6, wherein the vertical pusher comprises an actuator that is arranged vertically, and wherein the end of a piston comes to bear directly or indirectly against a component disposed at the end of the first rail so as to transfer it to the second rail, the stroke of the piston guaranteeing that the component is transferred to at least the position of the non-return device.

8. The dispenser device according to claim 6, wherein the vertical pusher comprises a part of longitudinal shape, such as a rod, arranged vertically under the second rail so as to come to bear against a component disposed at the end of the first rail and so as to transfer it to the second rail beyond the non-return device, said part being activated by the actuation mechanism that actuates the plate.

9. The dispenser device according to claim 5, which device further comprises a regulation system that regulates conveying of the components from the first rail to the second rail, said regulation system being arranged to close off at least in part the passage between said first rail and said second rail when a component is awaiting extraction in the downstream portion of the temporary storage system.

10. The dispenser device according to claim 6, wherein the regulation system comprises the non-return device, said non-return device comprising a pivotally mounted locking piece and a return spring for urging said locking piece to return to its locking position, said locking piece comprising:
an upper portion forming a non-return abutment against a component that is engaged in the second rail and that has gone past said locking piece;
an intermediate portion comprising a holder that holds a component that is inserted into the second rail while a component is already waiting in the downstream portion of the storage system; and
a lower portion arranged for either closing off, at least in part, the passage between the first rail and the second rail so long as a component is held by the intermediate portion, or opening up the passage between said first rail and said second rail whenever no component is held by said intermediate portion.

11. The dispenser device according to claim 5, wherein the transfer mechanism further comprises at least a third rail adjoining the upper end of the second rail, said third rail making it possible to transfer components from the inside of the magazine to the outside thereof.

12. The dispenser device according to claim 1, which device further comprises a mixer means for mixing the components dumped in the main magazine, said mixer means being arranged to stir the components and to change their positions in the magazine.

13. The dispenser device according to claim 12, wherein the mixer comprises an element secured to the plate, the vertical movements of the plate making it possible to move said element in the magazine for mixing the components.

14. The dispenser device according to claim 1, wherein the actuation mechanism that actuates the plate comprises a pneumatic actuator.

15. The dispenser device according to claim 1, which device further comprises at least one secondary magazine coupled at an opening to the vertical wall of the main magazine, said device further comprising a gate for closing the opening and control devices that control the gate so as to fill the main magazine by it being fed from the secondary magazine.

16. The dispenser device according to claim 15, wherein the gate is mounted to slide vertically relative to the vertical wall of the magazine, so as to move it above or below the opening and so as to open up said opening.

17. The dispenser device according to claim 16, wherein the control devices that control the gate comprise at least one horizontal ledge secured to or integral with the inside face of the gate and extending above the components dumped in the main magazine, and a vertical actuation system for moving the gate and for managing its position relative to the opening, in such a manner as to open up or as to close off said opening depending on the quantity of components in the main magazine.
